(19) United States
(12) Patent Application Publication
(10) Pub. No.: US 2006/0026297 A1
(43) Pub. Date: Feb. 2, 2006

(54) COMPUTER SYSTEM WITH MULTIPLE DATA ACCESS CHANNELS AND CONTROL METHOD THEREOF

(76) Inventors: Shao-Tsu Kung, Taipei City (TW); Yi-Hung Shen, Taipei City (TW); Shu-Hua Tsai, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/908,874

(22) Filed: May 31, 2005

(30) Foreign Application Priority Data
Aug. 2, 2004 (TW) 93123058

(51) Int. Cl. G06F 15/173

(52) U.S. Cl. 709/239

(57) ABSTRACT

A computer system with multiple data access channels is provided. The computer system is suitable for transmitting data between a communication module and a host module. The multiple data access channels mainly comprise a first data access channel, a controller, and a second data access channel. Wherein, the first data access channel is connected between the communication module and the host module for transmitting the data. In addition, the controller is connected to the host module to transmit the data to/from the host module. Moreover, the second data access channel is connected between the controller and the communication module. When the host module enters a power-saving mode, the first channel is in an off state, and the communication module can transmit the data to/from the controller via the second channel.

### CROSS-REFERENCE TO RELATED APPLICATION

This application claims the priority benefit of Taiwan application serial no. 93123058, filed on Aug. 2, 2004. All disclosure of the Taiwan application is incorporated herein by reference.

### BACKGROUND OF THE INVENTION

1. Field of the Invention

The present invention relates to a computer system with multiple data access channels and a control method thereof, and more particularly, to a computer system wherein a second data access channel can be used to replace a first data access channel for transmitting data when the computer system enters a power-saving mode, and a control method thereof.

2. Description of the Related Art

In order to fulfill the internal hardware/software management requirement for the current computer system, a set of advanced configuration and power management interface (ACPI) specification have been defined for modern computer systems, so that more power management functions can be used. At present, five different functions (S1˜S5) of power managements are defined in the ACPI specification under different level of power saving (power-saving) status. Wherein, S1 and S2 are also known as “Power On Suspend.” As suggested by its name, it means that the main power is still provided by the power supply, but power to the system or monitor has been suspended. S3 is also known as “Suspend to RAM” (STR), which means that after power to the system is suspended, the system data and the context of each device are stored into a memory before the main power is shut down, and only an auxiliary power is supplied to the memory and other related circuits for saving the memory data. S4 is also known as “Suspend to Disk” (STD), which means that after power to the system is suspended, the system data and the context of each device are stored into a hard disk drive before the main power is shut down, and auxiliary power needs not to be supplied to the related circuits, and data will not be lost. S5 refers to the “soft off” mode in modern computer systems.

In general, after the portable computer (also known as notebook or laptop computer) top-cover is closed by the user, the computer system receives an instruction and shuts down the main power or monitor based on the configured power-saving status, and then enters a power-saving mode. Meanwhile, only a small portion of the power is reserved to support the data storage operation of the memory in related circuits, such that major electricity can be saved. Therefore, the Central Processing Unit (CPU), the north bridge chip (NB), the south bridge chip (SB), and the hard disk drive (HDD) inside the computer system are all in a suspended or off state to comply with the power saving specification. Likewise, under the power-saving mode, the host module cannot send or receive any data or instruction via a data transmission interface, and the sending and receiving operation can only be made after the computer system resumes its normal mode and the main power is supplied to the host module.

FIG. 1 schematically shows a data access channel of a conventional communication module. As shown in FIG. 1, when the main power is activated, the transmission of instruction or data can be accessed between a communication module 100 and a host module 108 (either a north bridge chip 112 or a south bridge chip 114) via a data access channel 120. For example, data such as meeting calendar, logbook, or e-mails can be transmitted to the communication module 100 via the Internet, Local Area Network (LAN), or Wireless Local Area Network (WLAN), and then transmitted to the host module 108, or displayed on the monitor. Therefore, the user can acquire instant information from the outside via the data access channel 120 and be notified of the instant incoming message. Wherein, the data access channel 120 can be a parallel bus interface which has higher data transmission speed.

It should be noted that the data access channel 120 can only be accessed between the host module 108 and the communication module 100 when the main power is activated. However, in a normal power supply operation, each component, the CPU 110 and the monitor consume such a great amount of electricity that the life span of the battery is significantly reduced. On the other hand, once the host module 108 enters a power-saving mode, the data access channel 120 is forced to cut off the communication link, which will interrupt the communication of small data such as the meeting calendar, logbooks, or e-mails. Accordingly, the ordinary computer system is not able to satisfy both requirements of power saving and instant data transmission.

In this situation, the structure, method and utilization for the foregoing conventional computer system and its control method are clearly still in inconvenience and disadvantages, and then are to be further solved under intention. In order to solve the issues existing in the computer system and its control method, the related manufacturers have made a lot of efforts to find the solution. However, in a long time, a proper design has not been completely developed yet. The usual computer system and the control method do not have proper structure either to solve the foregoing issues. Clearly, the issues are the strongly intended to be solved.

In consideration the foregoing disadvantages, inventor has intention to propose a novel computer system and control method with multiple data access channels, based on the knowledge and practical design experience of the inventor under a lot of research efforts. After continuous research and design, continuously fabricating the prototypes for improvements, the invention has proposed the invention in practical value.

### SUMMARY OF THE INVENTION

The invention is to overcome the disadvantages existing in the current computer system, and provide a novel structure for the computer system with multiple data access channels. The invention can solve the issue that when the computer system enters the power-saving mode, another data access channel is provided for transmitting instant data or information, so as to improve practical use.

Another objective of the invention is to overcome the disadvantages existing in control method of the current computer system, and provide a novel control method with multiple data access channels. The invention can solve the issue that when the computer system enters the power-saving mode, another data access channel is provided for transmitting instant data or information, so as to improve practical use.

In order to achieve the objectives, the following technology can be used for implement. The present invention provides a computer system with multiple data access channels. The computer system comprises a host module having a power-saving mode; a communication module for transceiving data, a first data access channel coupled between the communication module and the host module for transmitting data, wherein when the host module enters the power-saving mode, then the first data access channel is in an off state; a controller coupled to the host module, capable of transmitting data between the controller and the host module; a second data access channel coupled between the controller and the communication module, wherein when the host module enters the power-saving mode, the communication module can transmit data with the controller via the second data access channel; and a display unit coupled with the controller, so as to display the information being transmitted through the second data access channel.

In accordance with the objectives and the issues to be solved, it can be further implemented.

In the foregoing computer system with multiple data access channels, the controller comprises a storage unit, and the controller can store data received from the communication module in the storage unit.

In the foregoing computer system with multiple data access channels, when the data stored in the storage unit reaches a predetermined threshold, the controller activates the host module and releases the power-saving mode, such that the data stored in the storage unit can be updated to the host module.

In the foregoing computer system with multiple data access channels, when the data stored in the storage unit reaches a predetermined threshold, the communication module is shut down to stop data transmission.

In the foregoing computer system with multiple data access channels, when the data stored in the storage unit reaches a predetermined threshold, the data is saved by a First In First Out (FIFO) manner.

In the foregoing computer system with multiple data access channels, the host module includes a central processing unit, a north-bridge chipset, a south-bridge chipset.

In the foregoing computer system with multiple data access channels, it is a notebook computer.

In the foregoing computer system with multiple data access channels, the display unit is an auxiliary screen of the computer system.

In order to achieve the objects mentioned above, the present invention can be implemented by technologies as follows. The present invention provides a method for controlling multiple data access channels. The method is suitable for use in a computer system comprising a host module, a communication module, a controller, and a display unit. Wherein, the controller comprises a storage unit. The method for controlling multiple data access channels in the present invention comprises the following steps. It is determined whether or not the host module is operated in a power-saving mode or in a normal mode. If the host module is operated in a normal mode, the communication module transmits data to/from the host module via a first data access channel. Then, if the host module enters a power-saving mode, a communication link of the first data access channel is cut off, and a second data access channel is activated, by way of which the communication module stores its received data to the controller, and the incoming message is displayed on the display unit. When the data stored in the storage unit reaches a predetermined threshold, the controller performs any one of functions in a state instruction. The state instruction comprises a function of waking up system for allowing the controller to activate the host module and releases the power-saving mode, such that the data stored in the storage unit can be updated to the host module. And, when the host module enters a normal mode, determining whether or not the function of waking up system is performed, if it is then, updating the data stored in the storage unit to the host module, and if it is not, then activating the first data access channel, such that the communication module can transmit data to/from the host module via the first data access channel.

In accordance with the objectives and the issues to be solved, it can be further implemented.

In the foregoing method for controlling multiple data access channels, wherein the state instruction further comprises a function of shutting down the communication module for shutting down the communication module to stop the data transmission.

In the foregoing method for controlling multiple data access channels, wherein the state instruction further comprises a function of updating storage method, by the First In First Out (FIFO) method for storing data.

In the foregoing method for controlling multiple data access channels, wherein the host module includes a central processing unit, a north-bridge chipset, a south-bridge chipset.

In the foregoing method for controlling multiple data access channels, the host module is a notebook computer.

In the foregoing method for controlling multiple data access channels, the display unit is an auxiliary screen of the computer system.

In the foregoing method for controlling multiple data access channels, when the host enters the norma mode, the communication module can simultaneously store the received data to the controller via the second access channel.

In order to achieve the objects mentioned above, the present invention can be implemented by technologies as follows. The present invention provides a method for controlling multiple data access channels. The method is suitable for use in a computer system comprising a host module, a communication module, a controller, and a display unit. Wherein, the controller comprises a storage unit. The method for controlling multiple data access channels in the present invention comprises the following steps. It is determined whether or not the host module is operated in a power-saving mode or in a normal mode. If the host module is operated in a normal mode, the communication module transmits data to/from the host module via a first data access channel. Then, if the host module enters a power-saving mode, a communication link of the first data access channel is cut off, and a second data access channel is activated, by way of which the communication module stores its received data to the controller, and the incoming message is displayed on the display unit. When the data stored in the storage unit reaches a predetermined threshold, the controller performs activate the host module and release the power-saving mode for allowing the data stored in the storage unit to be updated to the host module. And, when the host module enters the normal mode, it is determined whether or not the host module is at the state being re-activated. If it is, then the data stored in the storage unit is updated to the host module. If it is not, then the first data access channel is activated and data is accessed between the communication module and the host module via the first data access channel. At the same time, the communication module used the second data access channel to stores the received data into the controller.

In accordance with the objectives and the issues to be solved, it can be further implemented.

In the foregoing method for controlling multiple data access channels, wherein when data stored in the storage unit reaches a predetermined threshold, the First In First Out (FIFO) method is used for storing data.

In the foregoing method for controlling multiple data access channels, wherein the host module includes a central processing unit, a north-bridge chipset, a south-bridge chipset.

In the foregoing method for controlling multiple data access channels, the host module is a notebook computer.

In the foregoing method for controlling multiple data access channels, the display unit is an auxiliary screen of the computer system.

In comparing with the conventional method, the present invention clearly has the advantages and the effects. In view of the foregoing descriptions, the present invention includes the technologies as follows.

In order to achieve the foregoing objectives of the invention, the invention provides a computer system with multiple data access channels. The computer system comprises a host module, a communication module, a first data access channel, a controller, a second data access channel, and a display unit. Wherein, the host module comprises a power-saving mode, and the communication module is used for sending and receiving data. In addition, the first data access channel is coupled between the communication module and the host module for transmitting data. When the host module enters the power-saving mode, the first data access channel is in an off state. Further, the controller is coupled to the host module such that the data can be transmitted between the controller and the host module. Moreover, the second data access channel is coupled between the controller and the communication module. When the host module enters the power-saving mode, the communication module can transmit data to/from the controller via the second data access channel. Furthermore, the display unit is coupled to the controller for displaying a message transmitted by the second data access channel.

In accordance with one embodiment of the present invention, the controller comprises, for example, a storage unit, and the controller stores the data received from the communication module into the storage unit. In addition, when the data stored in the storage unit reaches a predetermined threshold, the controller activates the host module and releases the power-saving mode, such that the data stored in the storage unit can be updated to the host module. Alternatively, the controller can shut down the communication module to stop data transmission, or save the data by a First In First Out (FIFO) manner.

In order to achieve the objects mentioned above, the present invention provides a method for controlling multiple data access channels. The method is suitable for use in a computer system comprising a host module, a communication module, a controller, and a display unit. Wherein, the controller comprises a storage unit. The method for controlling multiple data access channels in the present invention comprises the following steps. It is determined whether or not the host module is operated in a power-saving mode or in a normal mode. If the host module is operated in a normal mode, the communication module transmits data to/from the host module via a first data access channel. Then, if the host module enters the power-saving mode, a communication link of the first data access channel is cut off, and a second data access channel is activated, by way of which the communication module stores its received data to the controller, and the incoming message is displayed on the display unit. When the data stored in the storage unit reaches a predetermined threshold, the controller activates the host module and releases the power-saving mode, such that the data stored in the storage unit can be updated to the host module. In addition, when the host module enters the normal mode, it is determined whether or not the host module is reactivated. If it is yes, the data stored in the storage unit is updated to the host module. If it is no, the first data access channel is activated and the second data access channel is deactivated, and the data is transmitted between the communication module and the host module via the first data access channel.

In the foregoing method for controlling multiple data access channels, wherein when data stored in the storage unit reaches a predetermined threshold, the First In First Out (FIFO) method is used for storing data.

By the foregoing technologies, the computer system with multiple data access channels and the control method have the advantages as follows. The invention activates the second data access channel to replace the first data access channel, which is cut off under the power-saving mode as a communication disadvantage. Also and, the controller uses the second data access channel to maintain the link with the communication module, and the message received by the communication module is displayed on the display unit. As a result, in one hand, the computer system remains in the power-saving mode for saving power. On the other hand, the small amount message such as the meeting calendar, the log information, or e-mail in usual daily work can be accessed via the second data access channel. Also and, the instant message can be informed to the user via the display unit.

In summary, the invention is directed to a computer system with multiple data access channels and the control method. The computer system with multiple data access channels is suitable for transmitting data between a communication module and a host module. The multiple data access channel includes a first data access channel and a second data access channel. Wherein the first data access channel is coupled between the communication module and the host module for transmitting data. In addition, the controller is coupled to the host module, and data can be transmitted between the controller and the host module. Also and, the second data access channel is coupled between the controller and the communication module. When the host module enters the power-saving mode, the first data access channel is at an off state, and the communication module can transmit data with the controller via the second data access channel. The invention is suitable in use when the computer system enters the power-saving mode, and provides another data access channel for transmitting instant message or information. The invention therefore has significantly practical use with advantages. The conventional computer system and method do not disclose the design structure and method similar to the present invention in public. The present invention can effectively improve the structure, the control method and the function, and the technology has achieved novelty and non-obviousness.

### BRIEF DESCRIPTION OF THE DRAWINGS

The accompanying drawings are included to provide a further understanding of the invention, and are incorporated in and constitute a part of this specification. The drawings illustrate embodiments of the invention, and together with the description, serve to explain the principles of the invention.

FIG. 1 schematically shows a data access channel of a conventional communication module.

FIG. 2 schematically shows a block diagram of a computer system with multiple data access channels according to one embodiment of the present invention.

FIG. 3 schematically shows a flow chart illustrating a method for controlling multiple data access channels according to one embodiment of the present invention.

FIG. 4 schematically shows a flow chart illustrating a method for controlling multiple data access channels according to another embodiment of the present invention.

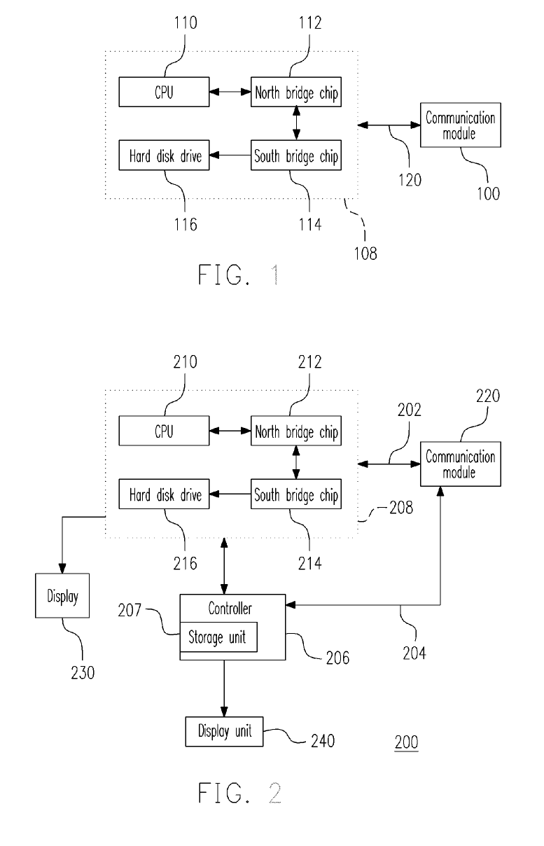

### DESCRIPTION OF THE EMBODIMENTS

To further describe the objective of the invention and show the effect, the accompanying drawings with preferred embodiment, according to the structure, method, step features and effect of the computer system with multiple data access channels and the control method in the invention, are described as follows.

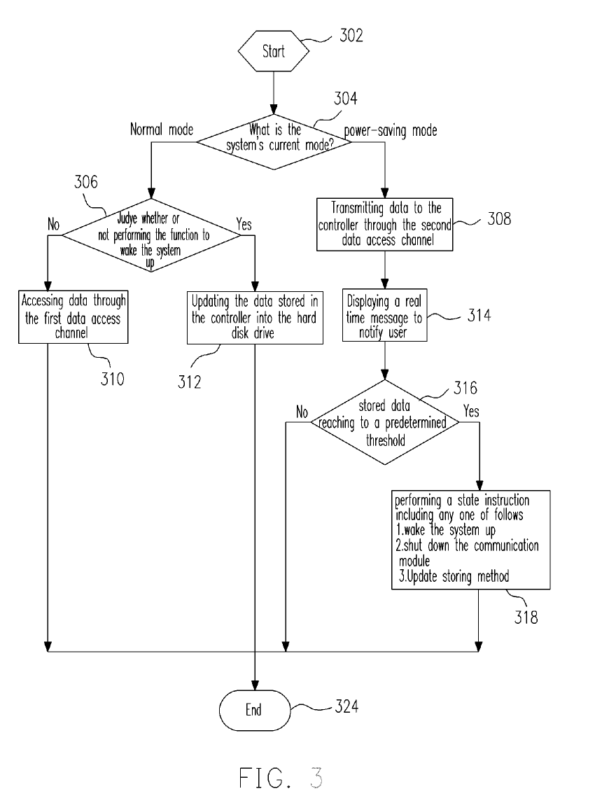

FIG. 2 schematically shows a block diagram of a computer system with multiple data access channels according to one embodiment of the present invention. As shown in FIG. 2, a computer system 200 comprises a host module 208, a communication module 220, a first data access channel 202, a second data access channel 204, and a controller 206. Wherein, the first data access channel 202 is connected between the host module 208 (which comprises a central processing unit 210, a north bridge chip 212, a south bridge chip 214, a hard disk drive 216, and so on) and the communication module 220. The second data access channel 204 is connected between the controller 206 and the communication module 220.

In the present embodiment, under a normal power supplying mode, the communication module 220 maintains connection with the host module 208 (either the north bridge chip 212 or the south bridge chip 214) by the first data access channel 202. Wherein, the first data access channel 202 can be a parallel bus interface or other interface with high transmission speed. When the communication module 220 receives a small data such as the meeting calendar, logbook, or e-mails, an instant message is displayed on a display unit 230 (e.g. a large panel display), such that the user can be notified of the incoming message. However, since the main power of the computer system 200 or monitor stays on, the electricity consumption is increased and the life span of the battery is reduced. If the computer system 200 enters a power-saving mode, the communication link of the communication module 220 is forced to cut off, and the data transmission is discontinued. Therefore, a second data access channel is provided in the present embodiment, by which the communication link between the controller 206 and the communication module 220 is kept in connection when the host module 208 enters a power-saving mode.

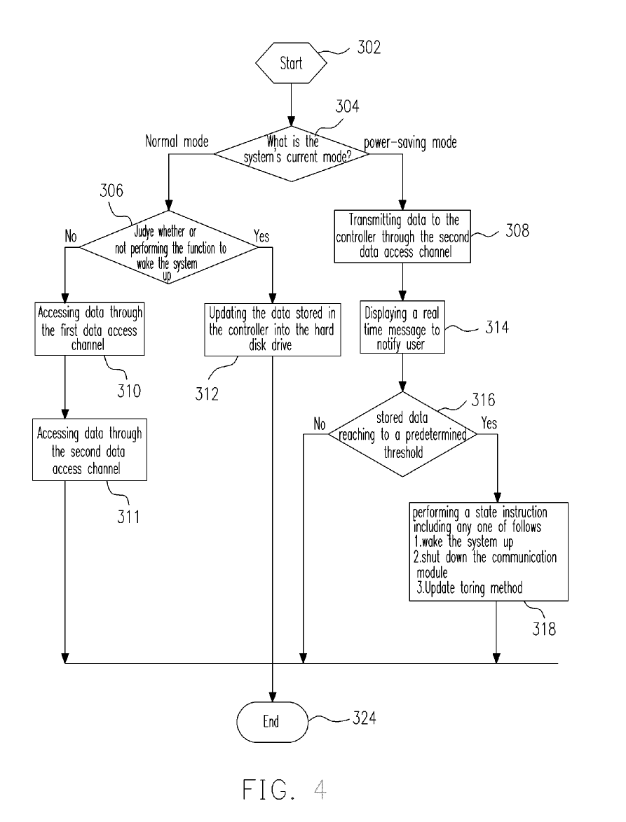

FIG. 3 schematically shows a flow chart illustrating a method for controlling multiple data access channels according to one embodiment of the present invention. First, the process starts (step 302), and then the system operation mode is determined (step 304). If it is determined that the host module 208 is in a normal mode, i.e. the power on state, the communication link between the communication module 220 and the host module 208 is kept connected. It is judged whether or not the function to wake up the system is performed (step 306). If it is yes, a data update operation is performed wherein the data originally stored in the storage unit 207 is saved into the hard disk drive 216 (step 312). If there is no data stored in the storage unit 207, the data transmission is performed via the first data access channel under a normal activation procedure (step 310) and the process is completed (step 324).

In addition, when the portable computer top-cover is closed and the system detects that the host module 208 is in a power-saving mode, the main power provided to the host module 208 or the display unit 230 is immediately shut down in the power-saving mode. In addition, the communication link of the first data access channel 202 is cut off, so the data or message transmission to the host module 208 stops. It should be noted that when the host module 208 is in a power-saving mode, the controller 206 can be operated in a normal power supply mode such that the controller 206 can temporarily replace the host module 208, and the second data access channel 204 is activated to keep the communication link between the controller 206 and the communication module 220 being in connection. Wherein, the controller 206 can be an embedded microprocessor chip, and the second data access channel 204 can be a lower speed parallel bus or serial bus interface. When the communication module 220 receives small data such as meeting calendar, logbook, or e-mails in daily work, the data can be transmitted to the controller 206 via the second data access channel 204 (step 308), and displayed on a display unit 240 (e.g. a small panel display or an auxiliary screen), so as to notify the user of the incoming message (step 314).

Please refer to FIGS. 2 and 3. In the present embodiment, the controller 206 can also comprise a storage unit 207 (e.g. a Dynamic Random Access Memory, DRAM) for storing part of the instant data, including small data such as meeting calendar, logbook, or e-mails. It is judged whether or not the data stored in the storage unit 207 reaches a predetermined threshold (step 316), then a state function including any one of the following function is performed (step 318).

(a) Waking up the system, which allows the controller to activate the host module and release the power-saving mode, for allowing the data stored in the storage unit to be updated to host module.

(b) Shutting down the communication module 220, such that the communication module 220 does not receive any more data.

(c) Updating storing method of data, that is, by a First In First Out (FIFO) method for storing data.

FIG. 4 schematically shows a flow chart illustrating a method for controlling multiple data access channels according to another embodiment of the present invention. The only difference between the present embodiment and the previous embodiment is that, in the present embodiment, when the host module 208 is in a normal mode or the portable computer top-coverer is not closed, data transmission can not only be accessed via the first data access channel 202 but also via the second data access channel 204 (step 311), and the data is stored in the storage unit 207 of the controller 206. In other words, when it is in a normal mode or the portable computer top-cover is not closed, the display unit is still able to display the small data such as the meeting calendar, logbook, or e-mails.

In summary, the computer system with multiple data access channels and the control method thereof in the present invention can be used in a computer system, such as a portable computer, a PDA, a smart cellular phone, or a computer system having LAN or WLAN capability. Wherein, the communication link between the controller and the communication module is kept connection by the second data access channel, and a message related to the data is displayed on a display unit, such that small data such as meeting calendar, logbook, or e-mails can be transmitted to the storage unit inside the controller via the second data access channel when the computer system is in a power-saving mode, and the user can be notified of an instant message through the display unit.

Although the invention has been described with reference to a particular embodiment thereof, it will be apparent to one of the ordinary skill in the art that modifications to the described embodiment may be made without departing from the spirit of the invention. Accordingly, the scope of the invention will be defined by the attached claims, not by the above detailed description.

What is claimed is:

1. A computer system with multiple data access channels, comprising:
a host module having a power-saving mode;
a communication module for sending and receiving data;
a first data access channel connected between the communication module and the host module for transmitting the data, wherein when the host module enters the power-saving mode, the first data access channel is in an off state;
a controller connected to the host module for transmitting the data with the host module;
a second data access channel connected between the controller and the communication module, wherein when the host module enters the power-saving mode, the communication module transmits the data with the controller via the second data access channel; and
a display unit connected to the controller for displaying a message according to the transmitted data via the second data access channel.

2. The computer system with multiple data access channels of claim 1, wherein the controller comprises a storage unit, and the controller stores the data received by the communication module in the storage unit.

3. The computer system with multiple data access channels of claim 2, wherein when the data stored in the storage unit reaches a predetermined threshold, the controller activates the host module and releases the power-saving mode, such that the data stored in the storage unit can be updated to the host module.

4. The computer system with multiple data access channels of claim 2, wherein when the data stored in the storage unit reaches a predetermined threshold, the communication module is shut down to stop the data transmission.

5. The computer system with multiple data access channels of claim 2, wherein when the data stored in the storage unit reaches a predetermined threshold, the data is stored in the storage unit in a First In First Out (FIFO) method.

6. The computer system with multiple data access channels of claim 1, wherein the display unit is an auxiliary screen of the computer system.

7. A method for controlling multiple data access channels, suitable for use in a computer system, the computer system comprising a host module, a communication module, a controller, and a display unit, wherein the controller comprises a storage unit, and the method for controlling multiple data access channels comprising:
determining whether the host module is in a power-saving mode or in a normal mode, and when the host module is in the normal mode, the communication module transmits data to/from the host module via a first data access channel;
when the host module enters the power-saving mode, cutting off a communication link of the first data access channel, and activating a second data access channel, wherein the data received by the communication module is stored in the controller via the second data access channel, and a message according to the transmitted data is displayed by the display unit, and when the data stored in the storage unit reaches a predetermined threshold, the controller performing any one of functions in a state instruction, and the state instruction comprising a function of waking up system for allowing the controller to activate the host module and releases the power-saving mode, such that the data stored in the storage unit can be updated to the host module; and
when the host module enters the normal mode, determining whether or not the function of waking up system is performed, if it is then, updating the data stored in the storage unit to the host module, and if it is not, then activating the first data access channel, such that the communication module can transmit the data to/from the host module via the first data access channel.

8. The method for controlling multiple data access channels of claim 7, wherein the state instruction further comprises a function of shutting down the communication module for shutting down the communication module to stop the data transmission.

9. The method for controlling multiple data access channels of claim 7, wherein the state instruction further comprises a function of updating storage method, by the First In First Out (FIFO) method for storing the data.

10. The method for controlling multiple data access channels of claim 7, wherein the display unit comprises an auxiliary screen of the computer system.

11. The method for controlling multiple data access channels of claim 7, wherein when the host enters the normal mode, the communication module can simultaneously store the received the data to the controller via the second access channel.
